(19) United States
(12) Patent Application Publication
(10) Pub. No.: US 2006/0129822 A1
(43) Pub. Date: Jun. 15, 2006

(54) Method of content identification, device, and software

(75) Inventors: Freddy Snijder, Eindhoven (NL); Jan Alexis Daniel Nesvadba, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/525,176

(22) PCT Filed: Jul. 21, 2003
(86) PCT No.: PCT/IB03/03289

§ 371 Date: Feb. 22, 2005

(30) Foreign Application Priority Data
Aug. 26, 2002 (EP) 02078517.6

(51) Int. Cl. H04L 9/00

(52) U.S. Cl. 713/176; 715/723; 715/719

(57) ABSTRACT

The method of content identification consists of creating a signature to comprise one or more sub-signatures. A sub-signature is created by averaging values of a feature in multiple frames of a content item (24). The electronics device (62) is able to retrieve a first signature of a first content item from a storage means (66) and to receive a second content item using a receiver (68). The device has a control unit (70) which is able to create one or more sub-signatures by averaging values of one or more features in multiple frames of the second content item and using the one or more sub-signatures to create a second signature. The control unit (70) is also able to determine similarity between the two signatures by determining similarity of sub-signatures for a similar feature. The software is able to create a signature for a content item by averaging values of a feature in multiple frames in a sequence of frames in the content item.

The invention relates to a method of content identification, comprising the step of creating a first signature for a first content item comprising a first sequence of frames.

The invention further relates to an electronic device comprising an interface for interfacing with a storage means storing a first signature of a first content item, the first content item comprising a first sequence of frames; a receiver able to receive a signal comprising a second content item, the second content item comprising a second sequence of frames; and a control unit able to use the interface to retrieve the first signature from the storage means, able to create a second signature for the second content item, and able to determine similarity between the first signature and the second signature.

The invention further relates to software enabling upon its execution a programmable device to function as an electronic device.

An embodiment of the method is known from EP 0 248 533. The known method performs real-time continuous pattern recognition of broadcast segments by constructing a digital signature from a known specimen of a segment, which is to be recognized. The signature is constructed by digitally parameterizing the segment, selecting portions among random frame locations throughout the segment in accordance with a set of predefined rules to form the signature, and associating with the signature the frame locations of the portions. The known method is claimed to be able to identify large numbers of commercials in an efficient and economic manner in real time, without resorting to expensive parallel processing or to the most powerful computers.

As a drawback of the known method, it can only be executed in real time in an economic manner if the number of random frame locations is limited. Unfortunately, limiting the number of frame locations also limits the reliability of the pattern recognition.

It is a first object of the invention to provide a method of the kind described in the opening paragraph, which can be executed in real time in an economic manner while achieving a relatively high reliability of pattern recognition.

It is a second object of the invention to provide an electronic device of the kind described in the opening paragraph, which is able to perform real-time pattern recognition with a relatively high reliability.

It is a third object of the invention to provide software of the kind described in the opening paragraph, which can be executed in real time in an economic manner while achieving a relatively high reliability of pattern recognition.

According to the invention the first object is realized in that the step of creating the first signature comprises creating a first sub-signature to comprise a first sequence of first averages, a first average being stricken of values of a feature in multiple frames in the first sequence of frames. A feature may be, for example, frame luminance, frame complexity, Mean Absolute Difference (MAD) error as used by MPEG2 encoders, or scale factor as used by MPEG audio encoders. A frame may be an audio frame, a video frame, or a synchronized audio and video frame.

An embodiment of the method of the invention further comprises the step of creating a second signature for a second content item comprising a second sequence of frames; in which the step of creating the second signature comprises creating a second sub-signature to comprise a second sequence of second averages, a second average being stricken of values of the feature in multiple frames in the second sequence of frames. The embodiment further comprises the step of determining similarity between the first and the second signature; and said step of determining similarity between the first and the second signature comprises determining similarity between the first and the second sub-signature.

Similarity between the first and the second signature may be used to identify a short audio/video sequence in other streams. For real-time comparison of tens or even hundreds of signatures, computational efforts must be low. A signature of new content may be generated and compared to a database of signatures every N frames. Comparing signatures every frame will be computationally too intensive and even unnecessarily accurate in time. The signatures must be robust to noise and other distortions because a Personal Video Recorder-like device could have many different input sources ranging from high quality digital video data to low quality analogue cable or VHS signals. By averaging over multiple frames, the effects of noise and other distortions are reduced.

In an embodiment of the method of the invention, the step of determining similarity between the first and the second signature comprises calculating a coefficient of correlation between the first and the second signature and comparing the coefficient with a threshold. By averaging over multiple frames, a data set with a more or less normal distribution is obtained. The degree of normality of the distribution depends on the amount of frames being averaged. A good measure of similarity can be obtained by correlating two data sets with a normal distribution, e.g. using Pearson's correlation. Alternatively, a first average of a sequence of feature values could be subtracted from a second average of a sequence of feature values to obtain a different similarity measure. By comparing a similarity measure with a threshold, a positive or negative identification can be obtained, which can be the basis for further steps.

The step of determining similarity between the first and the second signature may comprise calculating a coefficient of correlation between a first sub-sequence at a position in the first sequence of averages and multiple second sub-sequences in the neighborhood of a corresponding position in the second sequence of averages. This reduces the time-shifting problem, where, for instance, a missing frame in a content item might lead to a negative identification. Frames may be lost when displaying older VHS source material. Sometimes, the vertical synchronization is missed, resulting in lost frames. The time-shifting problem may also occur when a signature is not created every frame, but every plurality of frames.

The coefficient of correlation between the first sub-sequence and the multiple second sub-sequences may be calculated by using weights, a weight being larger if a second sub-sequence is near the corresponding position and smaller if a second sub-sequence is remote from the corresponding position. Since time shifts between similar content items will more likely be minor than major, correlation is more likely to be accidental if the second element is remote from the corresponding position. Better identification can be achieved by using weights.

The step of creating a signature may comprise creating multiple sub-signatures, and similarity between the first and the second signature is determined by using the multiple sub-signatures. Although one sub-signature per signature may be sufficient in some instances, the combinatorial behavior of low-level AV features of a short video sequence is more likely to be unique to this sequence. The uniqueness of a signature comprising multiple sub-signatures depends on the amount of information it represents. The longer the feature sequences, thy more unique the signature can be. Also, the more different types of features are used simultaneously, and thus the more sub-signatures, the more unique the signature can be. Due to the uniqueness of a signature, a large number of signatures can be uniquely identified under a variety of conditions using a single, pre-defined, identification criterion. In case a service provider provides the signatures, the identification criterion could in principle be designed per signature. This is because the service provider is able to test identification criteria for a signature on a large amount of content beforehand. However, in case of signatures defined by a user, a single, pre-defined, identification criterion should suffice for all signatures.

Creating a sub-signature may comprise reducing the number of averages. This reduces the required amount of processing. Since feature values are averaged, sub-signatures can be sub-sampled without losing significant information. Large differences between values are more significant than small differences. Since differences between average feature values will be smaller than differences between feature values, the amount of average feature values can be smaller than the amount of feature values.

If the second content item is comprised in a third content item and the first and the second signature are similar, a further step may comprise skipping the second content item in the third content item. For instance, a signature could be made for an intro of a commercial block. Whenever the intro is identified, 3 minutes could be skipped. Alternatively, a signature could be made for a black or blue screen that is shown when no signal is present. The skipping could be done automatically or the user could press a button to skip a given amount of content.

A further step may comprise identifying boundaries between a first segment and a second segment of a third content item, and another step may comprise skipping the first segment in the third content item if the second content item comprises the first segment and the first and the second signature are similar. The first segment may be, for instance, a commercial. The second segment may be, for instance, another commercial or a part of a movie. The segments of commercial blocks can be identified by using more general discriminators and separators in the A/V domain. Segments that are inside a commercial block can be detected reliably and even the boundaries between segments can be identified. The signatures of detected segments can be stored in a database. New incoming content can be correlated in real-time with the existing signatures of segments in the database and if the correlation is high enough, the content will be tagged as commercial segment. Due to the fact that segments of commercial blocks are of a repetitive nature and vary in their position inside a commercial block, there is a good chance to learn reliable signatures of unknown commercials. With this method, the precision of a commercial block detector can be increased significantly.

A further step may comprise recording the second content item if the first and the second signature are similar. If the first signature was made for an intro of a comedy series, a Personal Video Recorder (PVR) using the method of the invention may start recording as soon as the first and the second signature are found to be similar. Recording may also be started in retroaction, using a time-shift mechanism. This is useful when the generic intro of a series is not at the beginning of the program. The first signature, a recording start-time and end-time relative to the position of the first sequence of frames in the first content item, and a set of channels to scan for the second signature could be given by the user or downloaded from a service provider. The method of the invention may also be used to search for a second signature in a database, retrieve the accompanying second content item from the database, and store the second content item.

A further step may comprise generating an alert if the first and the second signature are similar. A PVR using the method of the invention may alert a user by showing the content of interest in a Picture In Picture (PIP) window, with an icon and/or sound. The user could then decide to switch to the identified content by pressing a button on the remote control or to remove the alert. When the user switches to the identified content, he or she could start watching the identified content live or play, in retroaction, from the beginning of the content, using a time-shift mechanism.

According to the invention the second object is realized in that the control unit is able to create a first sub-signature from the first signature, the first sub-signature comprising a first sequence of averages of values of a feature in multiple frames in the first sequence of frames; to create a second sub-signature for the second signature by averaging values of the feature in multiple frames in the second sequence of frames; to determine similarity between the first and the second sub-signature; and to determine similarity between the first and the second signature in dependence upon the similarity between the first and the second sub-signature. The device of the invention may be a Personal Video Recorder (PVR), a digital TV, or a satellite receiver. The control unit may be a microprocessor. The interface may be a memory bus, an IDE interface, or an IEEE 1394 interface. The interface may have an internal or an external connector. The storage means may be an internal hard disk or an external device. The external device may be located at the site of a service provider.

In an embodiment of the device of the invention, the control unit is able to determine similarity between the first and the second signature by calculating a coefficient of correlation between the first and the second signature and comparing the coefficient with a threshold.

If the second content item is comprised in a third content item and the first and the second signature are similar, the control unit may be able to urge a further storage means to store the third content item without the second content item.

The control unit may be able to urge a further storage means to store the second content item if the first and the second signature are similar.

The control unit may be able to generate an alert if the first and the second signature are similar.

According to the invention the third object is realized in that the software comprises a function for creating a signature for a content item comprising a sequence of frames, the function comprising creating a sub-signature to comprise a sequence of averages, an average being stricken of values of a feature in multiple frames in the sequence of frames.

An embodiment of the software of the invention further comprises a function for determining similarity between two signatures by calculating a coefficient of correlation between the two signatures and comparing the coefficient with a threshold.

The software may be stored on an record carrier, such as a magnetic info-carrier, e.g. a floppy disk, or an optical info-carrier, e.g. a CD.

These and other aspects of the method and device of the invention will be further elucidated and described with reference to the drawings, in which:

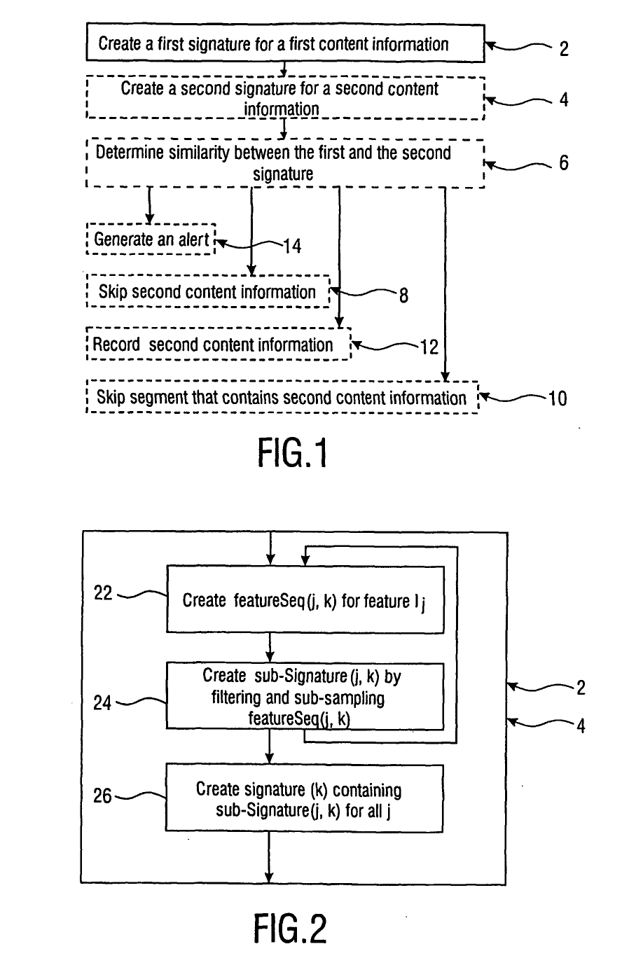

FIG. 1 is a flow chart of a favorable embodiment of the method;

FIG. 2 is a flow chart detailing a first and a second step of FIG. 1;

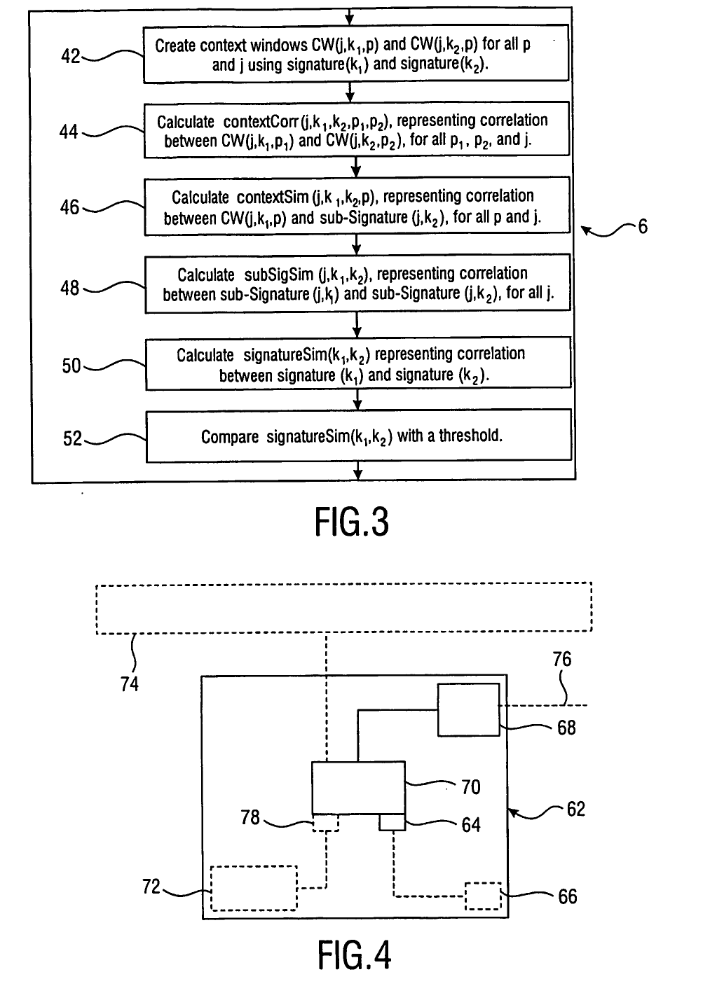

FIG. 3 is a flow chart detailing a third step of FIG. 1;

FIG. 4 is a block diagram of an embodiment of the electronic device;

FIG. 5 is a schematic representation of two steps of FIG. 2;

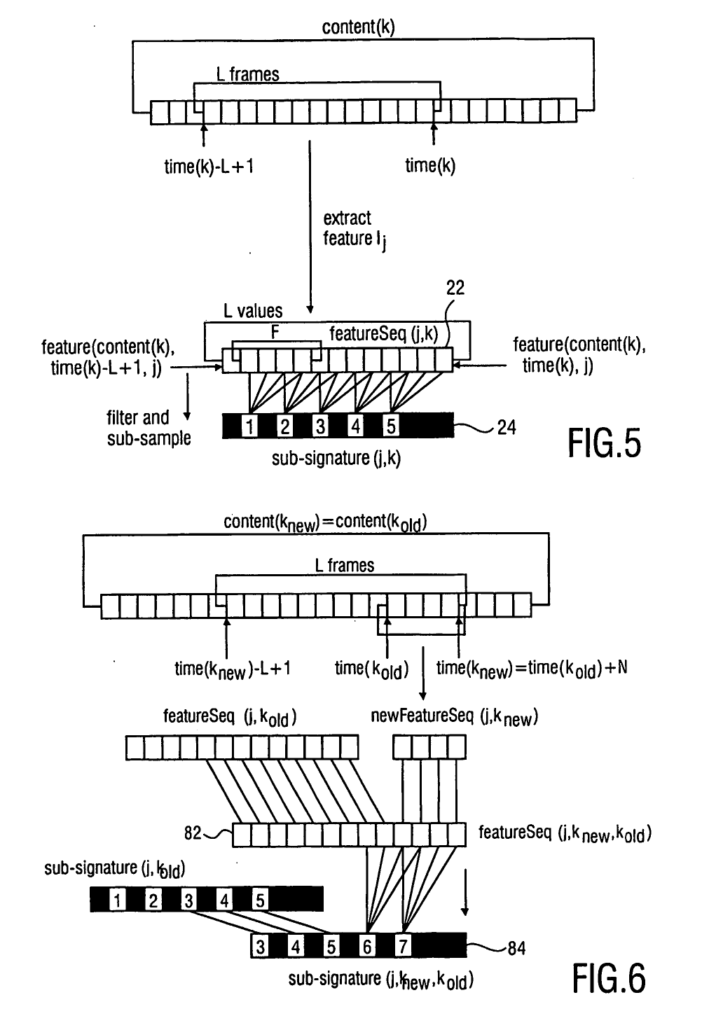

FIG. 6 is a schematic representation of a variation of the two steps of FIG. 5;

Corresponding elements within the drawings are denoted by the same reference numerals.

The method of FIG. 1 comprises a step 2 of creating a first signature for a first content item comprising a first sequence of frames. Step 2 comprises creating a first sub-signature to comprise a first sequence of first averages, a first average being stricken of values of a feature in multiple frames in the first sequence of frames.

The method of FIG. 1 may further comprise a step 4 of creating a second signature for a second content item comprising a second sequence of frames and a step 6 of determining similarity between the first and the second signature. Step 4 comprises creating a second sub-signature to comprise a second sequence of second averages, a second average being stricken of values of the feature in multiple frames in the second sequence of frames. Step 6 comprises determining similarity between the first and the second sub-signature.

Steps 2 and 4 may comprise creating multiple sub-signatures, and similarity between the first and the second signature may be determined by using the multiple sub-signatures.

If the second content item is comprised in a third content item and the first and the second signature are similar, an optional step 8 allows skipping the second content item in the third content item. A further step may comprise identifying boundaries between a first segment and a second segment of a third content item. Optional step 10 allows skipping the first segment in the third content item if the second content item comprises the first segment and the first and the second signature are similar. Optional step 12 allows recording the second content item if the first and the second signature are similar. Optional step 14 allows generating an alert if the first and the second signature are similar.

Steps 2 and 4 shown in FIG. 1 may both be subdivided into three steps, see FIG. 2. Step 22, see also FIG. 5, creates a sequence featureSeq(j,k) of feature values from a feature Iⱼ in multiple frames of a sequence of frames. k is a unique identifier for the sequence of frames. Content(k) is the content item comprising the sequence of frames, Time(k) is the time instance of the last frame of the sequence of frames expressed as a frame number in content(k). Feature (C, p, j) is the value of feature Iⱼ at time instance p in content item C. The sequence of feature values will have length L.
featureSeq(j,k)=[feature(content(k), time(k)−L+1,j) . . . feature(content(k), time(k), j)]
Step 24, see also FIG. 5, creates a first sub-signature using the sequence of feature values. The sequence of feature values is window-mean filtered with a filter window length of F frames using the following function:

$$filter ( j , k , p ) = \frac{1}{F} {\sum }_{m = 1}^{F} {featureSeq ( j , k )}_{p + m - 1}$$

By using the filter function, the problem of noise and distortions is reduced. Due to varying signal conditions or encoding conditions, the feature sequences can be distorted in multiple ways. Distortions could lead to a missed or a false identification of a video sequence.

Step 24 reduces the number of averages by using sub-sampling. Because a sequence of feature values is window-mean filtered, it could be sub-sampled without losing significant information. Sub-sampling every F/2 period has the advantage that the total number of data points in the signature decreases by a factor F/2 and thus makes it possible to compare more signatures simultaneously. r is the sub-sampling rate, the default value is F/2 assuming even F. K is the number of samples in the sub-sampled filtered sequence. K is a natural number that is rounded down if L−F+1 is not an integral multiple of r.

$$K = ⌊ \frac{L - F + 1}{r} ⌋$$

Sub-signature (j, k) is the sub-sampled and filtered sequence of feature values in content(k) in the filter window at time(k) for feature Iⱼ:
sub-signature(j,k)=[filter(j,k,r) filter(j,k,2r) . . . filter(j,k,Kr)]
Steps 22 and 24 may be repeated several times to create multiple sub-signatures for multiple features. Step 26 creates the first signature using the sub-signatures created in step 24. A signature consists of M sub-signatures:
signature(k)=[sub-signature^{T}(1,k) . . . sub-signature^{T}(M,k)]
Under general conditions, the proposed signature can be generated very efficiently during online operations. Every Nth frame, a new signature(k_{new}) of received or stored content can be made. The first time, a complete signature(k_{old}) must be made. However, after that, a new signature(k_{new}) can easily be created by using the N new frames. Sub-signature (j,k_{new},k_{old}) equals sub-signature (j,k_{new}) if N is a multiple of the sub-sampling rate r. Content (k_{new}) comprises content (k_{old}) and time(k_{new})=time(k_{old})+N.

In step 82 shown in FIG. 6, FeatureSeq (j, k_{new}, k_{old}) creates an updated sequence of feature values from a feature Iⱼ in multiple frames in an updated sequence of frames:
newFeatureSeq(j, k)=[feature(content(k), time(k)−N+1,j) . . . feature(content(k), time(k),j)]
featureSeq(j,k_{new},k_{old})=[featureSeq(j,k_{old})_{N+1} . . . featureSeq(j,k_{old})_{L} newFeatureSeq(j,k_{new})]
Filter (j, k_{new}, k_{old},p) is the updated filter function for a feature Iⱼ in multiple frames in the updated sequence of frames:

$$filter ( j , {k}_{new} , {k}_{old} , p ) = \{ \begin{matrix}filter ( j , {k}_{old} , p ) , & p \leq L - F - N + 1 \\ \frac{1}{F} {\sum }_{m = 1}^{F} {featureSeq ( j , {k}_{new} , {k}_{old} )}_{p + m - 1} , & otherwise\end{matrix}$$

Filter (j,k_{old},p) is pre-calculated. If N is an exact multiple of the sub-sampling rate r, then Z=N/r and sub-signature (j,k_{new},k_{old}), see step 84, is the updated sub-sampled filtered sequence. Sub-signature (j, k_{old}) is pre-calculated.

$$sub \text{-} signature ( j , {k}_{new} , {k}_{old} ) = [ \begin{matrix}sub \text{-} {signature ( j , {k}_{old} )}_{Z + 1} & ⋯ & sub \text{-} {signature ( j , {k}_{old} )}_{K} & filter ( j , {k}_{new} , {k}_{old} , ( K - Z + 1 ) r ) & ⋯ & filter ( j , {k}_{new} , {k}_{old} , Kr )\end{matrix} ]$$

Step 6 shown in FIG. 1 determining similarity between the first and the second signature may be subdivided into six steps in a favorable embodiment, see FIG. 3. In the favorable embodiment, sub-signatures are not compared as a whole but small sliding window sequences, called context windows, are compared instead. Using context windows solves the problem of shifts in timing between two similar or even equal sub-signatures. These shifts can occur because a signature is compared only every N frame. Using context windows also solves the problem of local shifts in the sequence due to missing or inserted frames. Although comparing the Fourier-power spectra of the sub-signatures may also solve this problem, because the power spectrum is invariant to shifts, differences at the borders of the sub-signatures could result in differences in the power spectra. Furthermore, computational efforts of this solution might be much higher.

Step 42 creates context windows for the first and the second signatures created in steps 4 and 6 shown in FIG. 1. Context windows are created for each value in each sub-signature in both signatures and comprise multiple values from a sub-signature around a position in the sub-signature. The Matrix of context windows for a sub-signature(j,k₁):

$$\begin{matrix}CW ( j , {k}_{1} ) = [ \begin{matrix}sub \text{-} {signature ( j , {k}_{1} )}_{1} & ⋯ & sub \text{-} {signature ( j , {k}_{1} )}_{W} \\ ⋮ & ⋰ & ⋮ \\ sub \text{-} {signature ( j , {k}_{1} )}_{K - W + 1} & ⋯ & sub \text{-} {signature ( j , {k}_{1} )}_{K}\end{matrix} ] \\ = [ \begin{matrix}{{cw}^{T} ( j , {k}_{1} )}_{1} \\ ⋮ \\ {{cw}^{T} ( j , {k}_{1} )}_{K - W + 1}\end{matrix} ]\end{matrix}$$

Step 44 calculates the correlation between each context window in a first sub-signature and each context window in a second sub-signature. The calculation comprises creating normalized context windows and calculating contextCorr(j,k₁,k₂,p₁,p₂):

$${ncw}^{T} ( j , {k}_{1} , p ) = \{ \begin{matrix}\frac{{{cw}^{T} ( j , {k}_{1} )}_{p} ) - mean ( {{cw}^{T} ( j , {k}_{1} )}_{p} )}{std ( {{cw}^{T} ( j , {k}_{1} )}_{p} )} , & std ( {{cw}^{T} ( j , {k}_{1} )}_{p} ) \neq 0 \\ {[ Not A Number ( NaN ) ]}^{1 \times W} , & std ( {{cw}^{T} ( j , {k}_{1} )}_{P} ) = 0\end{matrix} \\ NCW ( j , {k}_{1} ) = [ \begin{matrix}{ncw}^{T} ( j , {k}_{1} , p ) \\ ⋮ \\ {ncw}^{T} ( j , {k}_{1} , K - W + 1 )\end{matrix} ] \\ contextCorr ( j , {k}_{1} , {k}_{2} , {p}_{1} , {p}_{2} ) = \{ \begin{matrix}\frac{{ncw}^{T} ( j , {k}_{1} , {p}_{1} ) ncw ( j , {k}_{2} , {p}_{2} )}{W - 1} , & \begin{matrix}std ( {ncw}^{T} ( j , {k}_{1} , {p}_{1} ) ) \neq 0 ⋀ \\ std ( {ncw}^{T} ( j , {k}_{2} , {p}_{2} ) ) \neq 0\end{matrix} \\ NaN , & otherwise\end{matrix}$$

The proposed similarity measure is based on correlation. Correlation can always be consistently scaled between −1 and 1, independent of the mean and variance of the signatures. Consequently, correlation is also more robust to distortions than, for instance, the Mean Square Error. Context correlation is undefined if one of the window sequences is constant. Although another measure could be defined if one of the context window standard deviations is zero, this will make the overall signature similarity measure inconsistent. Thus, effectively only the non-constant parts are compared, which has the disadvantage that the comparison is less strict. Increasing the context window width can increase the number of non-constant parts; this, however, increases the computational load. Step 44 is repeated for each first sub-signature and each second sub-signature created for the same feature.

Step 46 calculates a coefficient of correlation contextSim(j,k₁,k₂,p) between a context window at position p in the first sub-signature and multiple context windows in the second sub-signature. The final context window similarity at position p in sub-signature(j,k₁) with the context window at a corresponding position p in sub-signature(j,k₂) is defined as the best context correlation with the context window at neighborhood positions p−Lₙ to p+Lₙ of sub-signature (j,k₂). Lₙ is the neighborhood radius. Q(j,k₁,k₂,p) is a set of positions from sub-signature (j,k₂), the positions being in the neighborhood of position p from sub-signature (j, k₁):

$$Q ( j , {k}_{1} , {k}_{2} , p ) = \{ q \text{:} \{ max \{ p - {L}_{n} , 1 \} , ⋯ , min \{ p + {L}_{n} , K - W + 1 \} \} \vert contextCorr ( j , {k}_{1} , {k}_{2} , p , q ) \neq NaN \}$$

$$contextSim ( j , {k}_{1} , {k}_{2} , p ) = \{ \begin{matrix}{max}_{q ∈ Q ( j , {k}_{1} , {k}_{2} , p )} ( contextCorr ( j , {k}_{1} , {k}_{2} , p , q ) ) , & Q ( j , {k}_{1} , {k}_{2} , p ) \neq Ø \\ NaN , & Q ( j , {k}_{1} , {k}_{2} , p ) = Ø\end{matrix}$$

Step 46 is repeated for each first sub-signature and each second sub-signature created for the same feature.

Step 48 calculates a coefficient of correlation subSigSim(j,k₁,k₂) between a first sub-signature (j, k₁) and a second sub-signature (j, k₂)

$$P ( j , {k}_{1} , {k}_{2} ) = \{ p \text{:} \{ 1 , … , K - W + 1 \} \vert contextSim ( j , {k}_{1} , {k}_{2} , p ) \neq NaN \}$$

$$subSigSim ( j , {k}_{1} , {k}_{2} ) = \{ \begin{matrix}\frac{1}{\vert P ( j , {k}_{1} , {k}_{2} ) \vert} {\sum }_{p ∈ P ( j , {k}_{1} , {k}_{2} )} contextSim ( j , {k}_{1} , {k}_{2} , p ) , & P ( j , {k}_{1} , {k}_{2} ) \neq Ø \\ NaN , & P ( j , {k}_{1} , {k}_{2} ) = Ø\end{matrix}$$

As shown above, the complete sub-signature similarity is defined by the average context similarities that are defined. If all context windows are constant, the sub-signature similarity is not defined. Finally, the complete signature similarity is defined as the average of defined sub-signature similarities. Step 48 is repeated for each first sub-signature and each second sub-signature created for the same feature.

Step 50 calculates a coefficient of correlation signatureSim(k₁,k₂) between the first and the second signature.

$$J ( j , {k}_{1} , {k}_{2} ) = \{ j \text{:} \{ 1 , … , M \} \vert subSigSim ( j , {k}_{1} , {k}_{2} ) \neq NaN \}$$

$$signatureSim ( {k}_{1} , {k}_{2} ) = \{ \begin{matrix}\frac{1}{2} ( 1 + \frac{1}{\vert J ( j , {k}_{1} , {k}_{2} ) \vert} {\sum }_{j ∈ J ( j , {k}_{1} , {k}_{2} )} subSig Sim ( j , {k}_{1} , {k}_{2} ) ) , & J ( j , {k}_{1} , {k}_{2} ) \neq Ø \\ NaN , & J ( j , {k}_{1} , {k}_{2} ) = Ø\end{matrix}$$

The signature similarity is scaled such that its range is from zero to one, although this is not necessary. Note that, in extreme situations, the signature similarity can be undefined if one or both of the signatures are completely constant.

Step 52 compares the coefficient with a threshold. When the coefficient is higher than the threshold, the first and the second signature and hence the first and second content item, e.g. audio/video sequences, can be identified as being equal. When the signatures are too simple, i.e. not specific enough, a good threshold will not exist. There are multiple signature generation parameters that can be varied to increase the specificity of the signatures. Identification quality could be further improved by generating multiple signatures for an audio/video sequence at multiple time instances, for instance, at time(k), time(k)+G, time(k)+2G, etc. In order to identify the sequence, a large percentage of the generated signatures should be positively identified. This improves the robustness and quality of the identification mechanism.

Weights may be used in step 46 to calculate the coefficient of correlation contextSim(j,k₁,k₂,p) at position p in the first sub-signature and multiple context windows in the second sub-signature of the second signature, a weight being larger if a context window in the second sub-signature is near the corresponding position p and smaller if the second element is remote from the corresponding position p. ContextSim(j,k₁,k₂,p) is redefined to incorporate a weight w(p,q):

$$Q ( j , {k}_{1} , {k}_{2} , p ) = \{ q \text{:} \{ 1 , … , K - W + 1 \} \vert contextCorr ( j , {k}_{1} , {k}_{2} , p , q ) \neq NaN \}$$

$$contextSim ( j , {k}_{1} , {k}_{2} , p ) = \{ \begin{matrix}{max}_{q ∈ Q ( j , {k}_{1} , {k}_{2} , p )} ( w ( p , q ) contextCorr ( j , {k}_{1} , {k}_{2} , p , q ) ) , & Q ( j , {k}_{1} , {k}_{2} , p ) \neq Ø \\ NaN , & Q ( j , {k}_{1} , {k}_{2} , p ) = Ø\end{matrix}$$

The weight function w(p,q) is a block function if all context windows in the second sub-signature that are in the neighborhood of the corresponding position p have equal weight. With this weight function, the original formulation as previously defined is preserved:

$$w ( p , q ) = \{ \begin{matrix}1 , & max \{ p - {L}_{n} , 1 \} \leq q \leq min \{ p + {L}_{n} , K - W + 1 \} \\ 0 , & otherwise\end{matrix}$$

The weight function w(p,q) is a triangular function if a weight is used in such a way that context windows further from corresponding position p are less important:

$$w ( p , q ) = \{ \begin{matrix}- \frac{1}{{L}_{w}} \vert p - q \vert + 1 , & max \{ p - {L}_{w} , 1 \} \leq q \leq min \{ p + {L}_{w} , K - W + 1 \} \\ 0 , & otherwise\end{matrix}$$

2L_{w} is the triangle base length.

Similarity can be evaluated efficiently during online operations. Every N frame, a new signature of received or stored content is made and compared with multiple reference signatures. For each reference sub-signature(j,k₁), a context correlation matrix CC(j,k₁,k₂) is maintained, containing the context correlation of each context window of sub-signature(j,k1) with all context windows in sub-signature(j,k₂).

$$CC ( j , {k}_{1} , {k}_{2} ) = [ {cc ( j , {k}_{1} , {k}_{2} )}_{1} ⋯ {cc ( j , {k}_{1} , {k}_{2} )}_{K - W + 1} ] = \\ [ \begin{matrix}context Corr ( j , {k}_{1} , {k}_{2} , 1 , 1 ) & ⋯ & context Corr ( j , {k}_{1} , {k}_{2} , 1 , K - W + 1 ) \\ ⋮ & ⋰ & ⋮ \\ contextCorr ( j , {k}_{1} , {k}_{2} , K - W + 1 , 1 ) & ⋯ & context Corr ( j , {k}_{1} {k}_{2} , K - W + 1 , K - W + t )\end{matrix} ]$$

A context similarity matrix is calculated by using neighborhood-weighting matrix W:

$$W = [ \begin{matrix}w ( 1 , 1 ) & ⋯ & w ( K - W + 1 , 1 ) \\ ⋮ & ⋰ & ⋮ \\ w ( 1 , K - W + 1 ) & ⋯ & w ( K - W + 1 , K - W + 1 )\end{matrix} ]$$

The context similarity matrix:

$$CS ( j , {k}_{1} , {k}_{2} ) = \\ [ contextSim ( j , {k}_{1} , {k}_{2} , 1 ) ⋯ contextSim ( j , {k}_{1} , {k}_{2} , K - W + 1 ) ] = max ( W . * CC ( j , {k}_{1} , {k}_{2} ) )$$

The matrix max(A) operation finds the maximum per column of A. All NaN elements of A are discarded from the maximum operation. If all elements of a column are NaN, the maximum value for that column is NaN. The ‘.*’ operator is the element-wise matrix multiplication operator. SubSigSim(j,k₁,k₂) and signatureSim(k₁,k₂) can be calculated by using the context similarity matrix.

Because an updated signature(k_{2new}) where time(k_{2new}) minus time(k_{2old}) equals N only contains Z (=N/r) new values at the end of the sub-signatures, only Z new normalized context windows are calculated. For the Z new context windows in sub-signature(j,k_{2new}), the context correlation with the (K−W+1) context windows of sub-signature(j,k₁) is calculated. These correlation values are used to update the context correlation matrix CC(j,k₁,k₂):=CC(j, k₁, k_{2new}). The Z new normalized context windows in sub-signature (j,k₁):

$$newNCW ( j , {k}_{2} ) = [ \begin{matrix}{new}^{T} ( j , {k}_{2} , K - W + 1 - ( Z - 1 ) ) \\ ⋮ \\ {new}^{T} ( j , {k}_{2} , K - W + 1 )\end{matrix} ]$$

The new context correlation matrix:

$$new CC ( j , {k}_{1} , {k}_{2} ) = \frac{NCW ( j , {k}_{1} ) new {NCW}^{T} ( j , {k}_{2} )}{W - 1}$$

$$CC ( j , {k}_{1} , {k}_{{2}_{new}} , {k}_{{2}_{old}} ) = [ {cc ( j , {k}_{1} , {k}_{{2}_{old}} )}_{Z + 1} ⋯ {cc ( j , {k}_{1} , {k}_{{2}_{old}} )}_{K - W + 1 - Z} \vert new CC ( j , {k}_{1} , {k}_{{2}_{new}} ) ]$$

It is assumed that any linear operation with a NaN results in a NaN. Thus, if one or both of the normalized context windows is constant, the resulting context correlation is NaN. By using the updated context correlation matrices, all the new similarities can be calculated.

The electronic device 62 of FIG. 4 comprises an interface 64 for interfacing with a storage means 66 storing a first signature of a first content item, the first content item comprising a first sequence of frames. The device 62 further comprises a receiver 68 able to receive a signal comprising a second content item, the second content item comprising a second sequence of frames. The device 62 also comprises a control unit 70 able to use the interface 64 to retrieve the first signature from the storage means 66, able to create a second signature for the second content item, and able to determine similarity between the first signature and the second signature. The control unit 70 is able to create a first sub-signature from the first signature, the first sub-signature comprising a first sequence of averages of values of a feature in multiple frames in the first sequence of frames. The first sub-signature may be extracted from the first signature or, if the first signature comprises raw data, e.g. a sequence of feature values, the first sub-signature may be calculated in the same way as the second sub-signature. The first signature may also need to be processed in other ways to create the first sub-signature. The control unit 70 is able to create a second sub-signature for the second signature by averaging values of the feature in multiple frames in the second sequence of frames. The control unit 70 is able to determine similarity between the first and the second sub-signature. The control unit 70 is able to determine similarity between the first and the second signature in dependence upon the similarity between the first and the second sub-signature. The storage means 66 may be comprised in the device 62 or may be an external device. The storage means 66 may comprise, for example, a hard disk or an optical storage medium. The receiver 68 may receive a signal using cable 76. The receiver 68 may receive, for example, signals from a cable operator or from a satellite dish.

The control unit 70 may be able to determine similarity between the first and the second signature by calculating a coefficient of correlation between the first and the second signature and comparing the coefficient with a threshold. If the second content item is comprised in a third content item and the first and the second signature are similar, the control unit 70 may be able to urge a further storage means 72 to store the third content item without the second content item. The control unit 70 may be able to urge a further storage means 72 to store the second content item if the first and the second signature are similar. The further storage means 72 may be comprised in the device 62 or may be an external device. The further storage means 72 may comprise, for example, a hard disk or an optical storage medium. The further storage means 72 and the storage means 66 may be physically or logically different parts of the same hardware. The control unit 70 may be able to use a further interface 78 to retrieve data from the further storage means 72. The interface 64 and the further interface 78 may be physically or logically different parts of the same hardware.

The control unit 70 may be able to generate an alert if the first and the second signature are similar. The alert may be displayed by using a display 74. The alert may also be audible. If the device 62 is a Digital TV, the display 74 may be comprised in the device 62. If the device 62 is a Personal Video Recorder, the display 74 may be an external device. The display 74 may be, for example, a CRT, a LCD, or a Plasma display. The user may be responsible for initiating the creation of the first signature. He or she could press a ‘generate signature’ button on a remote control of a PVR at the moment when a generic intro of a program is shown. After the button is pressed, the PVR could ask the user what to do when the first signature and the second signature are similar. If the user wants the program to be recorded, he or she may be able to specify the relative recording start time and end time but also a set of channels to scan. For instance, −3 min. 00 sec to +30 min 00 sec on ABC, CBS, and NBC. If a user wants to be alerted, he or she may be able to specify a set of channels to scan. The user may also be able to indicate that an occurrence of a similar signature is to be stored in a database enabling a user to jump to content or to skip content during playback.

The PVR may also be able to search for a second signature similar to the first signature in a collection of stored content and play back the second content item if the second signature is found. In this way, a user could jump from the start of one stored episode to the start of another stored episode of the same series. Another way to jump is to have predefined signatures. A user may be able to select a specific first signature from a list of signatures. With a button-press, the user can jump to the next instance of an intro. Instead of using a list, a small set of signatures could be programmed by the user on the remote control. If a user always likes to watch a specific news show or a specific TV comedy, he or she could program generic buttons on the remote control to link to these programs using the predefined signatures. If a user is playing back stored content and presses the generic button that links to the specific news show, the PVR will jump to a next identified intro of the specific news show. If the button is pressed again, the PVR will jump again to a next identified intro. The first and the second signature may be compared while the second content item is being stored in the collection of stored content.

While the invention has been described in connection with preferred embodiments, it will be understood that modifications thereof within the principles outlined above will be evident to those skilled in the art, and thus the invention is not limited to the preferred embodiments but is intended to encompass such modifications. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

‘Means’, as will be apparent to a person skilled in the art, are meant to include any hardware (such as separate or integrated circuits or electronic elements) or software (such as programs or parts of programs) which perform in operation or are designed to perform a specified function, be it solely or in conjunction with other functions, be it in isolation or in co-operation with other elements. The invention can be implemented by means of hardware comprising several distinct elements, and by means of a suitably programmed computer. In the device claim enumerating several means, several of these means can be embodied by one and the same item of hardware. ‘Software’ is to be understood to mean any software product stored on a computer-readable medium, such as a floppy disk, downloadable via a network, such as the Internet, or marketable in any other manner.

1. A method of content identification, comprising the step of:
creating a first signature for a first content item comprising a first sequence of frames (2), characterized in that:
the step of creating the first signature (2) comprises creating a first sub-signature (24) to comprise a first sequence of first averages, a first average being stricken of values of a feature in multiple frames in the first sequence of frames.

2. A method as claimed in claim 1, characterized in that it further comprises the step of creating a second signature for a second content item comprising a second sequence of frames (4);
in which the step of creating the second signature (4) comprises creating a second sub-signature (24, 84) to comprise a second sequence of second averages, a second average being stricken of values of the feature in multiple frames in the second sequence of frames;
the method further comprising the step of determining similarity between the first and the second signature (6); and
said step of determining similarity between the first and the second signature (6) comprises determining similarity between the first and the second sub-signature (48).

3. A method as claimed in claim 2, characterized in that the step of determining similarity between the first and the second signature (6) comprises calculating a coefficient of correlation between the first and the second signature (50) and comparing the coefficient with a threshold (52).

4. A method as claimed in claim 2, characterized in that the step of determining similarity between the first and the second signature (6) comprises calculating a coefficient of correlation between a first sub-sequence at a position in the first sequence of averages and multiple second sub-sequences in the neighborhood of a corresponding position in the second sequence of averages (46).

5. A method as claimed in claim 4, characterized in that the coefficient of correlation between the first sub-sequence and the multiple second sub-sequences (46) is calculated by using weights, a weight being larger if a second sub-sequence is near the corresponding position and smaller if a second sub-sequence is remote from the corresponding position.

6. A method as claimed in claim 2, characterized in that the step of creating a signature (2, 4) comprises creating multiple sub-signatures, and similarity between the first and the second signature (6) is determined by using the multiple sub-signatures.

7. A method as claimed in claim 2, characterized in that creating a sub-signature (24) comprises reducing the number of averages.

8. A method as claimed in claim 2, characterized in that, if the second content item is comprised in a third content item and the first and the second signature are similar, a further step comprises skipping the second content item in the third content item (8).

9. A method as claimed in claim 2, characterized in that a further step comprises identifying boundaries between a first segment and a second segment of a third content item, and another step comprises skipping the first segment in the third content item (10) if the second content item comprises the first segment and the first and the second signature are similar.

10. A method as claimed in claim 2, characterized in that a further step comprises recording the second content item (12) if the first and the second signature are similar.

11. A method as claimed in claim 2, characterized in that a further step comprises generating an alert (14) if the first and the second signature are similar.

12. An electronic device (62), comprising:
an interface (64) for interfacing with a storage means (66) storing a first signature of a first content item, the first content item comprising a first sequence of frames;
a receiver (68) able to receive a signal comprising a second content item, the second content item comprising a second sequence of frames; and
a control unit (70) able to use the interface (64) to retrieve the first signature from the storage means (66), able to create a second signature for the second content item, and able to determine similarity between the first signature and the second signature, characterized in that the control unit (70) is able to:
create a first sub-signature from the first signature, the first sub-signature comprising a first sequence of averages of values of a feature in multiple frames in the first sequence of frames;
create a second sub-signature for the second signature by averaging values of the feature in multiple frames in the second sequence of frames;
determine similarity between the first and the second sub-signature; and
determine similarity between the first and the second signature in dependence upon the similarity between the first and the second sub-signature.

13. A device as claimed in claim 12, characterized in that, the control unit (70) is able to determine similarity between the first and the second signature by calculating a coefficient of correlation between the first and the second signature and comparing the coefficient with a threshold.

14. A device as claimed in claim 12, characterized in that, if the second content item is comprised in a third content item and the first and the second signature are similar, the control unit (70) is able to urge a further storage means (72) to store the third content item without the second content item.

15. A device as claimed in claim 12, characterized in that the control unit (70) is able to urge a further storage means (72) to store the second content item if the first and the second signature are similar.

16. A device as claimed in claim 12, characterized in that the control unit (70) is able to generate an alert if the first and the second signature are similar.

17. Software enabling upon its execution a programmable device to function as an electronic device, comprising a function for creating a signature for a content item comprising a sequence of frames, the function comprising creating a sub-signature to comprise a sequence of averages, an average being stricken of values of a feature in multiple frames in the sequence of frames.

18. Software as claimed in claim 17, characterized in that it further comprises a function for determining similarity between two signatures by calculating a coefficient of correlation between the two signatures and comparing the coefficient with a threshold.

19. Software as claimed in claim 17, characterized in that it is stored on a record carrier.
